(19) United States
(12) Patent Application Publication
(10) Pub. No.: US 2026/0089246 A1
(43) Pub. Date: Mar. 26, 2026

(54) Screen Mirroring Accessory

(71) Applicants: Ankit Bhangar, Gurgaon (IN); Basav Sharma, New Delhi (IN)

(72) Inventors: Ankit Bhangar, Gurgaon (IN); Basav Sharma, New Delhi (IN)

(21) Appl. No.: 19/053,315

(22) Filed: Feb. 13, 2025

Related U.S. Application Data
(60) Provisional application No. 63/552,779, filed on Feb. 13, 2024.

(51) Int. Cl. H04M 1/02; G06F 1/16; H04M 1/22

(52) U.S. Cl. CPC H04M 1/0264; G06F 1/1607; G06F 1/1626; G06F 1/1649; G06F 1/1654; H04M 1/0262; H04M 1/22

(57) ABSTRACT

The disclosed screen mirroring accessory combines a high-brightness display, a large-capacity power bank, and versatile LED lighting in a durable casing. When connected to a mobile device, it allows users to see themselves while using the back camera. The LED lights offer settings like soft, warm, and natural light alongside a party mode with changing colors, making it a useful tool for various applications. A screen mirroring accessory is provided comprising housing having a front and back, a screen on the housing front, a circuit board that mirrors a connected mobile device display onto the screen, and means for attaching the accessory to a mobile device.

### CROSS REFERENCE TO RELATED APPLICATIONS

This application is a non provisional that claims priority from a provisional U.S. patent application No. 63/552,779 filed on Feb. 13, 2024.

### FIELD OF INVENTION

This invention relates to mobile accessories, focusing on devices that enhance mobile device photography and videography capabilities by providing screen mirroring, extended power, and customizable lighting.

### BACKGROUND

MagSafe, developed by Apple, revolutionizes the interaction between the iPhone (or any other MagSafe-supported device) and its accessories through a magnetic technology that simplifies attachment and enhances functionality. This system, characterized by an array of 18 rectangular magnets arranged in a circle around the phone's internal charging coil, enables accessories to effortlessly align and securely attach to the back of compatible phones. The defining feature of MagSafe is its ability to provide a strong and reliable connection with a single snap, ensuring that only MagSafe-compatible accessories, including cases and wallets, can connect.

The significance of MagSafe extends beyond just charging; it greatly benefits a wide range of users, especially content creators who require their devices to remain stable and charged during use. The technology's inclusion in products highlights its versatility. MagSafe ensures that accessories remain securely in place, offering stable and reliable functionality. This innovative approach to accessory design and integration demonstrates MagSafe's role in enhancing the overall mobile device experience, making it more convenient, efficient, and tailored to the needs of diverse users.

The surge in social media and influencer culture has revolutionized the importance of content quality, delineating the success of influencers. High-quality content, a key differentiator, often translates into higher engagement and earnings. In this visually-centric era, the demand for advanced mobile accessories has skyrocketed.

A YouTuber grappling with the limitations of a high-resolution back camera may find it challenging to achieve the perfect frame, leading to multiple retakes. Despite its superior quality, the back camera falls short of providing real-time framing feedback. Educational content creators may struggle with confidence in front of the camera without being able to see a view of what's being filmed. Tourists, often reliant on others to capture their memories, face the challenge of achieving the perfect photograph. As such, tourists may be forced to rely on entrusting camera phones to strangers resulting in awkward interactions. There exist several needs of a diverse user base, from content creators to photography enthusiasts.

### SUMMARY OF THE INVENTION

The disclosed screen mirroring accessory combines a high-brightness display, a large-capacity power bank, and versatile LED lighting in a durable casing. When connected to a mobile device, it allows users to see themselves while using the back camera. The LED lights offer settings like soft, warm, and natural light alongside a party mode with changing colors, making it a useful tool for various applications.

A screen mirroring accessory is provided comprising a housing have a front and back, a screen on the housing front, a circuit board that mirrors a connected mobile device display onto the screen, and means for attaching the accessory to a mobile device. The screen mirroring accessory can further include LED lights on the housing front, which can have different lighting modes and a power coil on the housing back for charging the connected mobile device. The means for attaching the accessory to a mobile device can be a ring of MagSafe magnets. The screen mirroring accessory can be connected to the mobile device via USB-C port. It can further

### BRIEF DESCRIPTION OF FIGURES

The accompanying drawings taken in conjunction with the detailed description will assist in making the advantages and aspects of the disclosure more apparent.

FIG. 1 is a 3D model render of a screen mirroring accessory showcasing how it will get attached to a MagSafe-enabled mobile device.

FIG. 2 is an exploded view of a screen mirroring accessory that shows the relationship of assembly of various components in the order of back (left) to front (right) inside the accessory.

FIG. 3 is an isometric view of a screen mirroring accessory showing the front and top right side of the final assembled accessory with the relevant components seen by a user which mainly covers the screen, the lights, buttons to use the device.

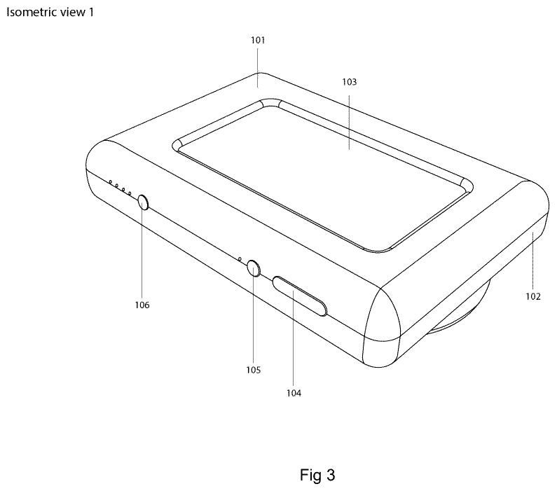

FIG. 4 is an isometric view of a screen mirroring accessory showing the bottom and top left side of the final assembled accessory with relevant components seen by a user which mainly covers the screen, the USB ports, and the lights.

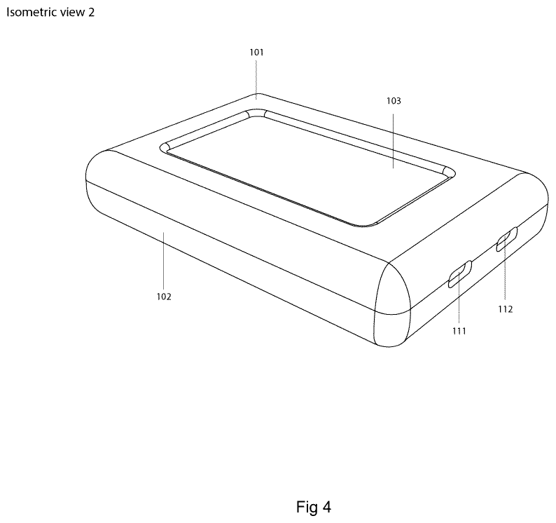

FIG. 5 is a bottom view of a screen mirroring accessory showing 2 ports that allow a user to connect a cable to mirror the mobile screen (left) as well as power the device (right).

FIG. 6 is a front view of a screen mirroring accessory showing the screen and the LED light.

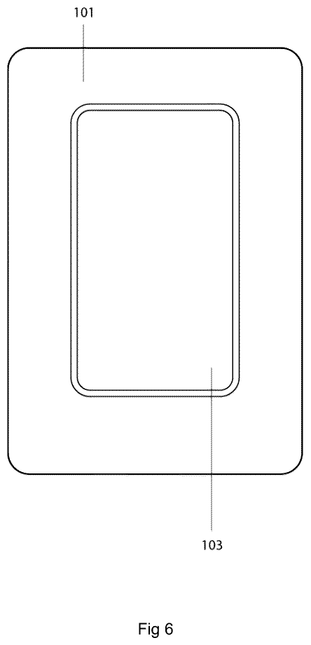

FIG. 7 is a rear view of a screen mirroring accessory showing the placement of the MagSafe magnets.

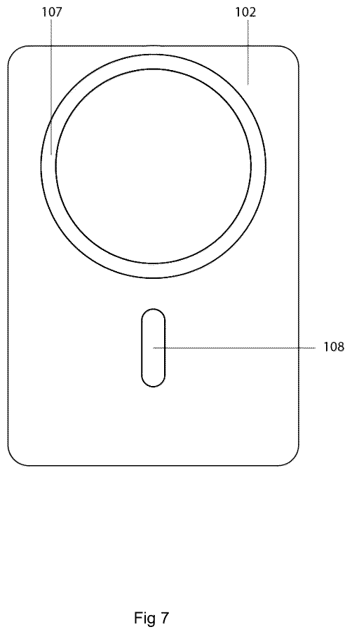

FIG. 8 is an electronic system architecture block diagram showing the interconnection of various functional components.

### DETAILED DESCRIPTION

Reference will now be made in detail to the present embodiments discussed herein, illustrated in the accompanying drawings. The embodiments are described below to explain the disclosed invention by referring to the Figures using like numerals. It will nevertheless be understood that no limitation of the scope is thereby intended, such alterations and further modifications in the illustrated invention, and such further applications of the principles as illustrated therein being contemplated as would normally occur to one skilled in the art to which the embodiments relate.

The disclosed screen mirroring accessory enhances mobile device camera capabilities by addressing the needs of a diverse user base of mobile device camera users, from content creators to photography enthusiasts. The screen mirroring accessory, hereinafter referred to as MagMirror, allows photographers to see what a rear-facing mobile device camera is capturing, aligning themselves appropriately in the frame to capture memories just as one envisions. Content creators find it easier to make videos with MagMirror because they can see themselves as they record. This helps them make videos faster and with less effort, since they don't have to keep redoing parts of their videos. MagMirror uses MagSafe technology to “snap” onto the back of any MagSafe-supported device. MagMirror's lightweight, magnetic design and the Qi2 wireless charging capability ensure mobile devices remain charged. MagMirror offers lighting modes with settings like soft, warm, and natural light, along with a dynamic party mode, catering to a range of ambient lighting needs and personalized lighting effects. As disclosed, MagMirror comprises a display to mirror the phone's display, a MagSafe-compatible power bank, and an LED strip with multiple lighting modes for photography and videography.

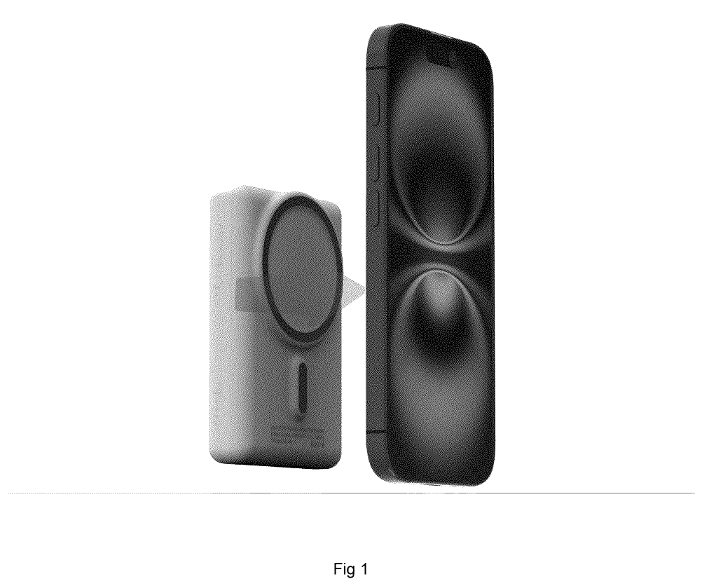

As illustrated in FIG. 1, a MagMirror is attached to a mobile device. Mobile devices include, but are not limited to, cellular phones, smartphones, tablets, PDAs, and laptops, where the spin grip stand is sized appropriately for the mobile device. In the preferred embodiment, the MagMirror is attached to the mobile device by Magsafe technology. However, for mobile devices that do not utilize Magsafe technology, other means of attaching or securing the MagMirror to the mobile device may be contemplated, where such means may be permanent or temporary. A USB C cable is provided while purchasing MagMirror. The cable is used to connected the device to the MagMirror. The cable provided is designed to blend in with the casing of the accessory making it seem like the cable is a part of the accessory. Once attached magnetically and the cable connected to the device, the user can view their device display mirrored on the MagMirror display. The user will open an app with camera access, toggle the back camera, and point the back camera to themself while recording themselves. MagMirror will display the user in the screen portion of the accessory.

The user can additionally switch on the lights if desired. There are 4 modes of the light: Soft light mode, Warm light mode, Daylight light mode, and Party mode. Soft light is ideal for portrait photography as it gently illuminates the subject, reducing harsh shadows and creating a flattering look. It can smooth out skin tones and bring a professional quality to the images. It's great for storytelling, casual talks, or any content where a more approachable look is desired. The warm light is perfect for creating moods-it's great for capturing videos that aim to feel homey, comfortable, or sentimental. This type of lighting is excellent for lifestyle vlogs, cooking shows, or any content that benefits from a more ‘lived-in’ or inviting atmosphere. White light is ideal for more energetic and vibrant content. It's great for dance videos, fitness routines, educational content, or any scenario where clarity and vibrancy are essential. Lastly, the Party Mode brings a vibrant, dancing multi-color hue that would make the individual stand out in the crowd. This feature can be used in night events like clubbing or concerts as a form of self-expression or unity. Regardless of the light, the user can also use it as a torch. The party mode of MagMirror not only enhances the ambiance but also sets the user apart in social settings. This unique feature has the potential to evolve into a customizable signature identifier, allowing users to personalize their social interactions.

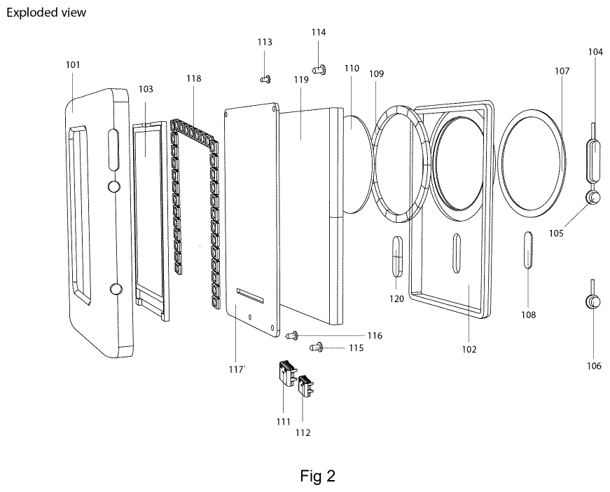

As illustrated in FIG. 2, the front housing (casing) 101 is attached to the back housing 102 to cover the internal components of the accessory. The front housing has a cut-out for the screen 103, a USB-C port 111 for screen mirroring, and the 112 port for charging. The housing is made of two materials, transparent ABS material covering the LED light 110 for light dissipation and solid ABS (or metallic) covering the remaining portion. The front housing also has clips, screws 113, 114, 115, and 116 to attach the back side 102 covering the entire accessory. The front housing may also have branding.

The back housing 102 is made of the same material as the front housing (ABS or metallic). In embodiments utilizing Apple MagSafe technology, the back housing will constitute the ring graphics 109 and a small straight line 120 which is the standard size for MagSafe. Along with this, the back can also have the power specification, power certification, and the branding of the accessory.

The button 104 is used to switch the light on and off along with controlling different modes of the LED light. The button 105 is to switch on and off the wireless charging. The button 106 is for the user to see the LED status represented by 4 LEDs each representing 25% of charging.

The screen 103 mirrors a mobile device connected through the device attachment. In the preferred embodiment, the screen is a 3-inch TFT display. As depicted, the component is housed on the level of the front housing 101. In other embodiments, a larger screen with different specifications may be preferred. The screen enables users to frame and compose shots using the back camera's high resolution. This feature is especially beneficial for content creators requiring precise framing and composition. In the preferred embodiment, the input to the screen will be via a USB-C cable, though no limitation as to the input means is intended.

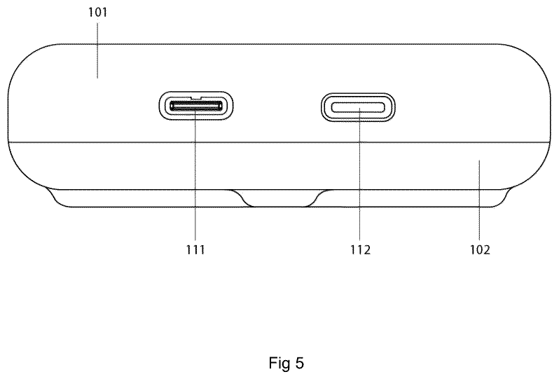

As illustrated in FIG. 5, two ports 111 and 112, which in the preferred embodiment are USB-C type ports. USB-C port 111 provides as the inputs for the cable to enable screen mirroring and USB-C port 112 provides as an input to charge the accessory when connected to a power output. Both ports are metallic and are connected to the main circuit 117 and have a connector pin providing the bridge between the main circuit and any external device. As depicted, the ports are integrated into the front housing 101.

As illustrated in FIG. 2, thirty-nine individual RGB LED 118 lights forming an inverted U-type pattern placed on top of the main circuit board 117 are controlled by button 104 to change the switch on/off and change between different lighting modes. Each LED light's power, intensity, and color is controlled by the circuit board. The LED light is positioned behind the transparent material on the front housing 101. In other embodiments, the MagMirror's lighting system includes up to 39 individually controlled, high-quality RGB LEDs. The different lighting modes include:
Soft light mode—The LED colors are more yellow
Warm light mode—The LED colors are yellow and white
Daylight mode—The LED colors are white P
arty mode—A preset pattern that fluctuates the lights between various colors.

The main circuit board 117 controls the LED lights 118, controls the power output to the MagSafe accessory via a coil 110 placed inside the ring of MagSafe magnets 109, controls the power input via USB-C port 112, charges the battery 119, and mirrors the mobile device onto the screen 104 connected via one of the cables. The circuit is also the bridge between the power button 103 and the LED lights 118. The circuit will be printed on a PCB board and all the components will be connected to the PCB board.

The main circuit board 117 is tightened to the front case 101 using 4 screens, two at the top 113 and 114 and two at the bottom 115 and 116. The USB C ports 111 and 112 are attached to the main circuit as well.

A Lithium-ion battery 119 of 4,000 mAh connected to the circuit board 117 is charged using the provided cable connected to the USB-C port 112. The battery charges a MagSafe-supported device via the coil placed inside the ring of MagSafe magnets 109. The battery will also have a protective layer to protect it from touching the Magnetic rings 109 and the circuit board 117.

A MagSafe magnetic ring 109 has multiple small magnets placed together to look like a right. The ring also has a power coil 110 centered within to wirelessly charge the supported device. The MagSafe ring follows the guidelines provided by Apple for MagSafe devices. The coil is connected to the main circuit 117. The magnetic ring 109 is mainly used to hold the accessory with the device as firmly as possible. The other part 120 of the MagSafe, is a small rectangular magnet providing additional support to connect the accessory to the MagSafe-enabled device. This small magnet 120 prevents the accessory from rotating when the attached device is in motion.

For MagSafe-compatible iPhones (iPhone 12 and above), the MagMirror will be magnetically attached and aligned to the MagSafe magnets, behind the phone. Additionally MagMirror also has rubber material applied 107 applied to the circular ring and the same rubber material 108 applied to the straight part. For non-MagSafe compatible devices, a magnetic ring is provided (in the same dimension as the MagSafe magnet) to attach the MagMirror. The free magnetic ring will have a side covered with adhesive to attach to the device. Other means of connecting the MagMirror to a mobile device are contemplated, and no limitation is intended.

Once the accessory is connected via MagSafe, or aligned by wireless charging coils of any other device, it will start charging the device via wireless charging (only supported to devices supporting wireless charging). The power bank of the MagMirror has a 4,000 mAh capacity. It supports Qi wireless charging with a transmission distance of ≤8 mm, offering both wired and wireless charging options. This capability ensures extended device usage, catering to users' needs requiring power on the go.

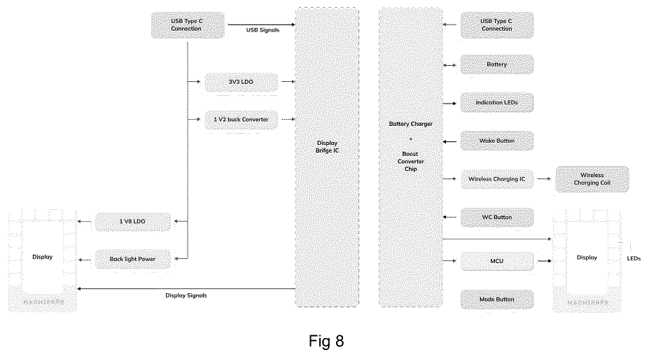

As illustrated in FIG. 8, the MagMirror features an integrated electronics architecture comprising four primary subsystems: a display system, power management circuitry, a control system, and an LED control module. In the display system, a Display Bridge integrated circuit processes USB signals from the Type-C connector and routes display data to the screen, while a combination of a 3.3 V LDO and a 1.2 V buck converter ensures stable power for display operations and a 1.8 V LDO together with dedicated backlight power manages illumination. The power management subsystem employs a battery charger paired with a boost converter chip to regulate overall power distribution, supports an integrated charging system for the internal battery, and accepts power input via the USB Type-C connector; additionally, a wireless charging IC connected to a charging coil facilitates MagSafe compatibility. A microcontroller unit (MCU) within the control system orchestrates device operation and LED pattern management, with dedicated buttons provided for cycling through lighting modes, controlling system power (wake), and managing the wireless charging function. Moreover, the LED control module features an MCU-driven LED array configured in a U-shape, enabling individual LED control for diverse lighting patterns as well as system status indication.

The design of the MagMirror prioritizes user-friendliness and portability. Its lightweight construction and magnetic attachment mechanism ensure stability and ease of use, making it an ideal accessory for a broad spectrum of smartphone users. The versatility of the MagMirror extends across various user scenarios. It's an invaluable tool not only for professionals in content creation but also for educators, tourists, and social media enthusiasts. The combination of screen mirroring, extended battery life, and adaptable lighting addresses a wide range of needs, positioning it as a comprehensive accessory in the smartphone accessory market.

The preceding description contains embodiments of the invention and no limitation of the scope is thereby intended. It will be further apparent to those skilled in the art that various modifications and variations can be made in the present invention without departing from the spirit or scope of the invention.

1. A screen mirroring accessory comprising:
a housing having a front and back;
a screen on the housing front;
a circuit board that mirrors a connected mobile device display onto the screen;
means for attaching the accessory to a mobile device.

2. The screen mirroring accessory of claim 1 further comprising:
LED lights on the housing front.

3. The screen mirroring accessory of claim 2, wherein the LED lights have different lighting modes.

4. The screen mirroring accessory of claim 1, wherein the means for attaching the accessory to a mobile device is by a ring of MagSafe magnets.

5. The screen mirroring accessory of claim 1, wherein the mobile device is connected via USB-C port.

6. The screen mirroring accessory of claim 1 further comprising:
a power coil on the housing back for charging the connected mobile device.
